(19) United States
(12) Patent Application Publication
(10) Pub. No.: US 2004/0113833 A1
(43) Pub. Date: Jun. 17, 2004

(54) Microwave detector using fet resistive mixer

(76) Inventor: Sang-Kun Lee, Seoul (KR)

Correspondence Address: Nixon & Vanderhye, 8th Floor, 1100 North Glebe Road, Arlington, VA, 22201-4714, US

(21) Appl. No.: 10/296,391

(22) PCT Filed: Jul. 22, 2002
(86) PCT No.: PCT/KR02/01370

(30) Foreign Application Priority Data
Nov. 20, 2001 (KR) 2001-71126

(51) Int. Cl. G01S 7/40

(52) U.S. Cl. 342/20; 342/175; 455/227

(57) ABSTRACT

Provided is a microwave detector including a resistive mixer that uses a field effect transistor (FET) for generating an intermediate frequency signal by combining a signal generated by an antenna and an output of a local oscillator. The microwave detector includes an antenna for receiving a radio signal; a modulator for modulating the radio signal by converting its frequency with a resistive mixer that uses one or a plurality of FET; a central processing unit for identifying the modulated signal and its frequency band, measuring the intensity of the signal, and outputting the same as a predetermined signal; and a display unit for outputting a visual or audio signal in response to the signal generated by the central processing unit, and selecting a mode of the output of a signal. The microwave detector including an FET is easy to make at a lower cost, hardly malfunctions, and further can operate with a little power.

### BACKGROUND OF THE INVENTION

1. Field of the Invention

The present invention relates to a microwave detector including a resistive mixer that uses a field effect transistor (FET) that generates an intermediate frequency signal by combining a signal generated by an antenna and an output of a local oscillator.

2. Description of the Related Art

FIG. 1 is a block diagram illustrating the configuration of a conventional radio signal detecting device fabricated using a horn antenna 100. Referring to FIG. 1, if microwave signals radiated from a speed gun (not shown) are received by the horn antenna 100, the received microwave signals are introduced into a waveguide (not shown), and a mixing diode 110 combines the microwave signals with an oscillating signal from a resonator 120 to shift the signals to an intermediate frequency in the waveguide. A demodulator 130 demodulates the signals shifted to the intermediate frequency, and if a controller 140 determines that the demodulated signals are microwave signals radiated from the speed gun, an output unit 150 informs a user of the presence of the speed gun.

There are two ways to realize a resistive mixer of the conventional microwave detector as shown in FIG. 2 and FIG. 3.

FIG. 2 is a view of a resistive mixer used in a conventional microwave detector. With the resistive mixer, a signal can be converted into an intermediate frequency signal by installing a mixer diode 201 at the middle point of the propagation path of a horn antenna, mixing a local oscillating signal, which is generated by a cavity, and a signal input to an antenna, and detecting the intermediate frequency signal from an output of the mixer diode. In detail, a microwave signal f_{R} is received via the antenna and then is supplied to the mixer diode 201. A local oscillating signal f_{L} is also oscillated by a gun diode oscillator 202 and then is supplied to the mixer diode 201. Next, the mixer diode 201 outputs an intermediate frequency signal f_{IF} having frequency that corresponds to a difference between the frequency of the microwave signal f_{R} and the frequency of the local oscillating signal f_{L}, i.e., f_{IF}=f_{L}−f_{R}. A driver 203 supplies a driving voltage to the gun diode oscillator 202.

FIG. 3 is a view of another resistive mixer of a conventional microwave detector. With the resistive mixer, a signal, which is received by a horn antenna, is converted into a low-frequency signal on a microstrip that is manufactured on a Teflon substrate or a PCB substrate having little loss rate on a high-frequency signal. Here, reference numerals 301 denotes a cross-section of the horn antenna, and reference numeral 302 denotes a connector that connects the horn antenna 301 with a mixer diode 303, which is a microstrip on which metal conductor is printed on a Teflon or PCB substrate. Reference numerals 303 and 304 denote the mixer diode and a microstrip that is printed on a substrate, respectively. A microwave signal f_{R}, which is emitted from a speed gun, is received via the horn antenna 301 and supplied to the mixer diode 303 via the connector 302. Meanwhile, a local oscillation signal f_{L} is input to the mixer diode 303 via the lower portion of the microstrip 304 that is positioned in the right direction of the mixer diode 303. The mixer diode 303 generates an intermediate frequency signal f_{IF} that has frequency corresponding to a difference between the frequency of the local oscillation signal f_{L} and the frequency of microwave signal f_{R}, which is received by the horn antenna 301, and then outputs the same via the microstrip 304.

The frequency of a signal used in the resistive mixers shown in FIGS. 2 and 3 is very high, e.g., 36 GHz. For this reason, parasitic capacitance and lead inductance are prone to be generated in the event that the general diode is used in resistive mixers shown in FIGS. 2 and 3. Thus, the general diode is not available in resistive mixers. Also, electrodes of the general diode are mechanically touched to be charged with electricity and thus may be easily damaged. A beam-lead type or chip-type diode is used, being united directly with a Teflon substrate instead of a general diode. In this case, a special conductive adhesive is, however, required to attach a beam-lead type or chip type diode to a Teflon substrate, and further, it is difficult to attach such a diode to a Teflon substrate.

### SUMMARY OF THE INVENTION

To solve the above problems, it is an object of the present invention to provide a microwave detector including a resistive mixer that uses a field effect transistor (FET).

To achieve one aspect of the above object, there is provided a resistive mixer used in a microwave detector, wherein a local oscillating signal is input to a gate terminal of an FET, a microwave signal, which is received via an antenna, is input to a drain terminal of the FET, and an intermediate frequency signal, which is made by combining the local oscillating signal and the microwave signal, is output from the drain terminal of the FET.

The local oscillating frequency signal is input to a gate terminal of the FET via a filter, together with gate bias voltage, the microwave signal is input to the drain terminal of the FET via a filter, and the intermediate frequency signal is obtained from the drain terminal via a filter.

The local oscillating frequency signal is input to gate terminals of first and second FETs via a balun, together with gate bias voltage, the microwave signal is input to drain terminals of the first and second FETs, and first and second intermediate frequency signals, which are made by combining the oscillating frequency signal and the microwave signal, but are 180° out of phase, are obtained from the drain terminals of the first and second FETs via a filter.

To achieve another aspect of the above object, there is provided a resistive mixer used in a microwave detector, wherein a local oscillating signal is input to a drain terminal of an FET, a microwave signal, which is received by an antenna, is input to a gate terminal of the FET, and an intermediate frequency signal, which is made by combining the oscillating frequency signal and the microwave signal, is output from the drain terminal of the FET.

The local oscillating frequency signal is input directly to the drain terminal of the FET via a filter, the microwave signal is input to the gate terminal of the FET via a filter, together with gate bias voltage, and a signal output, which is made by combining the oscillating frequency signal and the microwave signal, is obtained from the drain terminal via a filter.

The local oscillating signal is input to drain terminals of first and second FETs via a balun, the microwave signal is input to gate terminals of the first and second FETs together with gate bias voltage, and first and second intermediate frequency signals, which are made by combining the oscillating frequency signal and the microwave signal, but are 180° out of phase, are obtained from the drain terminals of the first and second FETs via a filter.

To achieve still another aspect of the above object, there is provided a microwave detector including an antenna for receiving a radio signal; a modulator for modulating the radio signal by converting its frequency with a resistive mixer that uses one or a plurality of FET; a central processing unit for identifying the modulated signal and its frequency band, measuring the intensity of the signal, and outputting the same as a predetermined signal; and a display unit for outputting a visual or audio signal in response to the signal generated by the central processing unit, and selecting a mode of the output of a signal.

The modulator includes a first local oscillator for outputting a signal whose frequency can be changed; a first resistive mixer for combining the radio signal, which is received via the antenna, and a signal output from the first local oscillator to output an intermediate frequency signal, which is made by combining the radio signal and the signal output from the first local oscillator, using an FET; an amplifier for amplifying the signal generated by the first resistive mixer; a plurality of second local oscillator for outputting signals having different frequencies; a second resistive mixer for combining the signal generated by the amplifier and the signal generated by the second local oscillator to output an intermediate frequency signal, which has frequency corresponding to a difference between the frequencies of these signals, using an FET; a modulator for modulating the signal generated by the second resistive mixer, and outputting the same as pulses; and a carrier-wave detector for detecting carrier wave from the signal generated by the modulator, and filtering the waveform of carrier wave.

The local oscillating frequency signal generated by the first local oscillator is input to a gate terminal of the FET of the first resistive mixer, a microwave signal, which is received via an antenna, is input to a drain terminal of the FET, and an intermediate frequency signal, which is made by combining the local oscillating signal and the microwave signal, is obtained from the drain terminal via a filter.

The local oscillating frequency signal generated by the first local oscillator is input to a drain terminal of the FET of the first resistive mixer, a microwave signal, which is received via an antenna, is input to a gate terminal, and an intermediate frequency signal, which is made by combining the local oscillating frequency signal and the microwave signal, is obtained from the drain terminal via a filter.

The local oscillating frequency signal generated by one of the plurality of second local oscillator is input to a gate terminal of the FET of the second resistive mixer, the signal, which is generated by the amplifier, is input to a drain terminal of the FET, and an intermediate frequency signal, which is made by combining the local oscillating signal and the signal generated by the amplifier, is obtained from the drain terminal via a filter.

The local oscillating frequency signal generated by one of the plurality of second local oscillator is input to a drain terminal of the FET of the second resistive mixer, the signal, which is generated by the amplifier, is input to a gate terminal, and an intermediate frequency signal, which is made by combining the local oscillating frequency signal and the signal generated by the amplifier, is obtained from the drain terminal via a filter.

The modulator includes a first local oscillator for outputting a signal whose frequency can be changed; a first resistive mixer for combining the radio signal, which is received via the antenna, and a signal output from the first local oscillator to output an intermediate frequency signal, which is made by combining the radio signal and the signal output from the first local oscillator, using two FETs; an amplifier for amplifying the signal generated by the first resistive mixer; a plurality of second local oscillator for outputting signals having different frequencies; a second resistive mixer for combining the signal generated by the amplifier and the signal generated by the second local oscillator to output an intermediate frequency signal, which has frequency corresponding to a difference between the frequencies of these signals, using two FETs; a modulator for modulating the signal generated by the second resistive mixer, and outputting the same as pulses; and a carrier-wave detector for detecting carrier wave from the signal generated by the modulator, and filtering the waveform of carrier wave.

The local oscillating frequency signal generated by the first local oscillator is input to gate terminals of first and second FETs via a balun of the first resistive mixer, a microwave signal, which is received by an antenna, is input to drain terminals of first and second FETs of the first resistive mixer, and first and second intermediate frequency signals, that have frequency corresponding to a difference between the frequencies of the local oscillating frequency signal and the microwave signal, but are 180° out of phase, are obtained from the drain terminals of the first and second FETs via a filter.

The local oscillating frequency signal generated by the first local oscillator is input to drain terminals of first and second FETs via a balun of the first resistive mixer, a microwave signal, which is received by an antenna, is input to gate terminals of first and second FETs of the first resistive mixer, and first and second intermediate frequency signals, that have frequency corresponding to a difference between the frequencies of the local oscillating frequency signal and the microwave signal, but are 180° out of phase, are obtained from the drain terminals of the first and second FETs via a filter.

The local oscillating frequency signal generated by one of the plurality of second oscillator is input to gate terminals of first and second FETs via a balun of the second resistive mixer, the signal, which is generated by the amplifier, is input to drain terminals of first and second FETs of the second resistive mixer, and first and second intermediate frequency signals, that have frequency corresponding to a difference between the frequencies of the local oscillating frequency signal and the signal generated by the amplifier, but are 180° out of phase, are obtained from the drain terminals of the first and second FETs via a filter.

The local oscillating frequency signal generated by one of the plurality of second oscillator is input to drain terminals of first and second FETs via a balun of the second resistive mixer, the signal, which is generated by the amplifier, is input to gate terminals of first and second FETs of the second resistive mixer, and first and second intermediate frequency signals, that have frequency corresponding to a difference between the frequencies of the local oscillating frequency signal and the signal generated by the amplifier, but are 180° out of phase, are obtained from the drain terminals of the first and second FETs via a filter.

### BRIEF DESCRIPTION OF THE DRAWINGS

The above object and advantages of the present invention will become more apparent by describing in detail preferred embodiments thereof with reference to the attached drawings in which:

FIG. 1 is a block diagram of the structure of a conventional microwave detector;

FIG. 2 is a view of a resistive mixer used in a conventional microwave detector;

FIG. 3 is a view of another resistive mixer used in a conventional microwave detector;

FIG. 4 is a view of a resistive mixer using one high electron mobility transistor (HEMT), which is a kind of a field effect transistor (FET), according to a first embodiment of the present invention;

FIG. 5 is a view of a resistive mixer using one HEMT according to a second embodiment of the present invention;

FIG. 6 is a view of a resistor mixer using two HEMTs according to the first embodiment of the present invention;

FIG. 7 is a view of a resistor mixer using two HEMTs according to the second embodiment of the present invention;

FIG. 8 is a block diagram of the structure of a microwave detector having a resistive mixer that uses an HEMT according to a first embodiment of the present invention; and

FIG. 9 is a view of the inner structure of a microwave detector having a resistive mixer that uses an HEMT according to the first embodiment of the present invention.

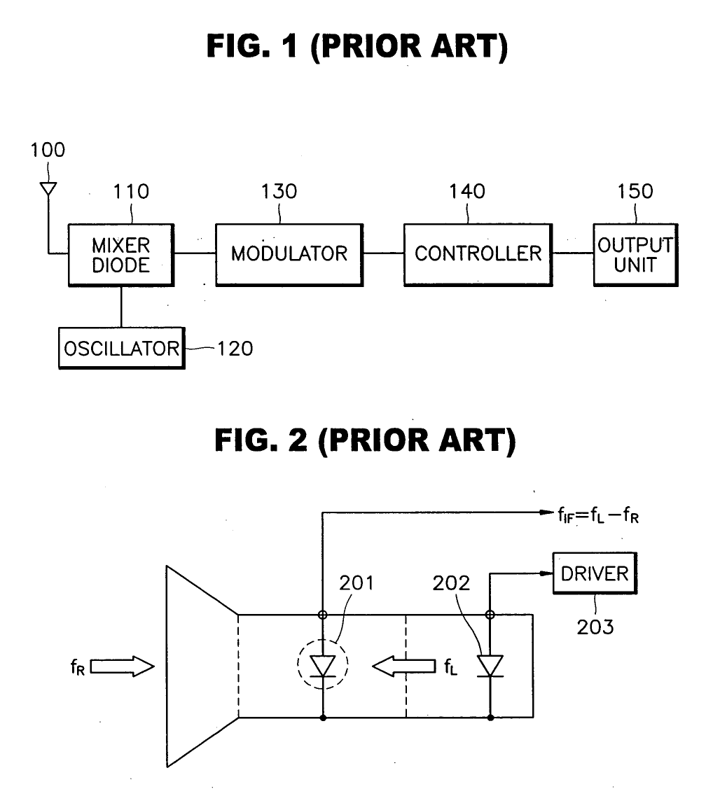

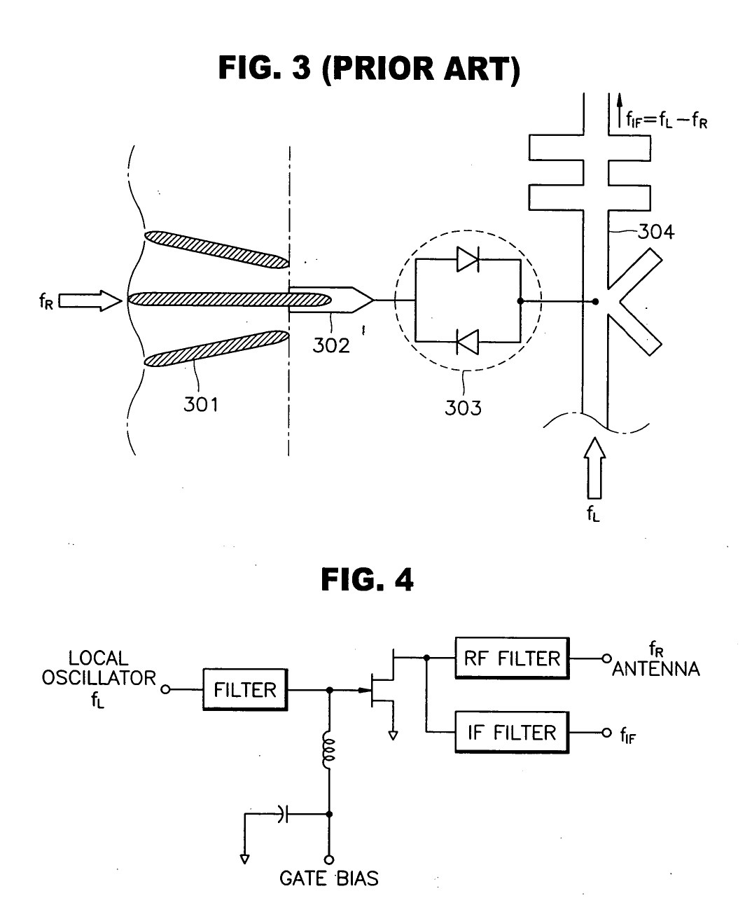

### DETAILED DESCRIPTION OF THE INVENTION

Hereinafter, the operational principles of a microwave detector according to the present invention will now be described in detail. The channel of a metal semiconductor field effect transistor (MESFET) operates the same as a resistor having the linear characteristics on the condition that voltage between its drain terminal and source terminal is low, or direct-current bias voltage is not applied to the drain terminal. These linear characteristics, however, disappear when voltage applied to the drain terminal is increased to accelerate the moving speed of an electric charge to reach the saturated velocity, and instead, the channel has the nonlinear characteristics. The voltage of the drain terminal having the linear characteristics varies from 0.1-0.5 V to 1.0 V according to the type of an FET. That is, the linear characteristics of the FET are strengthened with respect to a small signal of tens of milivolts. Further, the channel of such an FET is changed by a local oscillating signal, which is applied to a gate terminal, because local oscillating voltage changes the depth of a depletion layer. The resistance value of the channel of the FET reaches an infinite level when voltage, which is applied to the gate terminal, is reduced below turn-on voltage of the FET, whereas the resistance value of the channel of the FET has a low value, e.g., several Ohm, when the voltage is increased to the maximum, i.e., the voltage before conduction between drain terminal and source terminal of the FET is made, e.g., 0.5 V.

An FET resistive mixer according to the present invention operates due to a change in resistance of its channels. The following is some cases where the FET resistive mixer operates:

1) a local oscillating signal or direct-current bias voltage is applied to a gate terminal or a drain terminal of the FET;

2) a microwave signal, which is received via an antenna, is applied to the drain or gate terminal; or

3) an intermediate frequency signal is obtained from the drain terminal via a filter.

Hereinafter, a microwave detector including a resistive mixer that adopts a high electron mobility transistor (HEMT), which is a kind of an FET, according to preferred embodiments of the present invention, will now be described with FIGS. 4 through 9.

FIG. 4 is a circuit diagram of a resistive mixer using one HEMT according to a first embodiment of the present invention.

A signal f_{L}, which is oscillated by a local oscillator, is input to a gate terminal of the HEMT via a filter, together with gate bias voltage. A microwave signal f_{R} is input to a drain terminal of the HEMT via an RF filter. An intermediate frequency signal f_{IF} having the frequency corresponding to a difference between the frequency of the local oscillating signal f_{L} and the frequency of the microwave signal f_{R}, is obtained from the drain terminal via an IF filter.

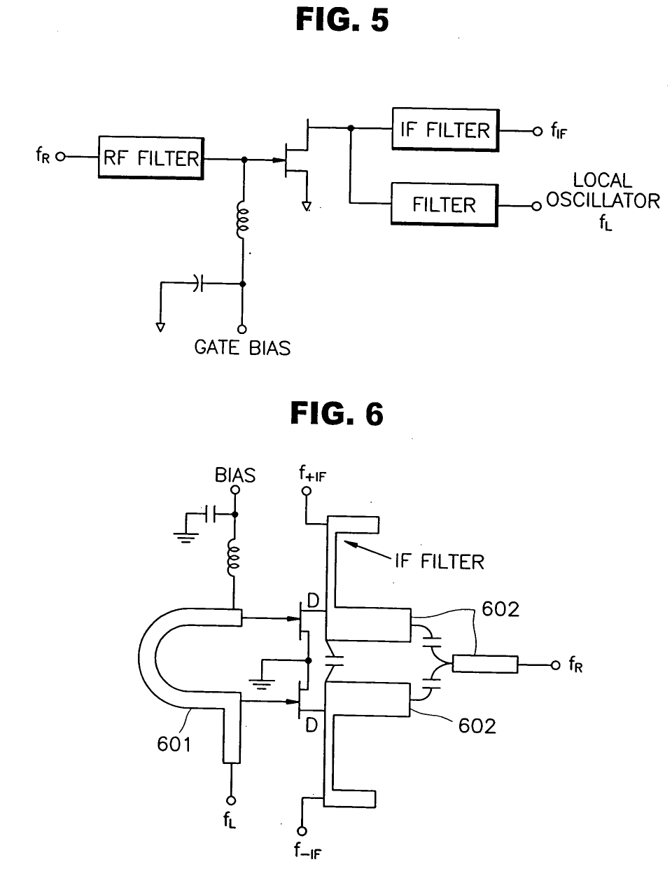

FIG. 5 is a circuit diagram of a resistive mixer using one HEMT according to a second embodiment of the present invention. The structure of the circuit of FIG. 5 is the same as the structure of the circuit of FIG. 4, except that the positions of the input terminals to which a local oscillating signal f_{L} and a microwave signal f_{R}, which is received by an antenna, are input, and the location of a filter, and an RF filter are switched, respectively. In other words, the local oscillating signal f_{L} is input to a drain terminal of the HEMT via the filter, and the microwave signal f_{R} is input to a gate terminal of the HEMT via the RF filter, together with bias voltage. Meanwhile, an intermediate frequency signal f_{IF}, which has frequency corresponding to a difference between the frequency of the local oscillating signal f_{L} and the frequency of the microwave signal f_{R}, is obtained from the drain terminal via an IF filter.

FIG. 6 is a circuit diagram of a resistive mixer using two HEMTs according to a first embodiment of the present invention. Reference numerals ‘601’ and ‘602’ denote a balun, and a microstrip for filtering microwave on a substrate, respectively. An oscillating signal f_{L}, which is oscillated by a local oscillator, is input to two gate terminals of two HEMTs via the balun 601, together with bias voltage. A microwave signal f_{R} is input to two drain terminals via the microstrip 602 that function as a filter. Further, two intermediate frequency signals f_{+IF} and f_{-IF}, which have frequency corresponding to a difference between the frequency of the local oscillating signal f_{L} and the frequency of the microwave signal f_{R}, but these signals are 180° out of phase, are obtained from the drain terminals via the IF filter.

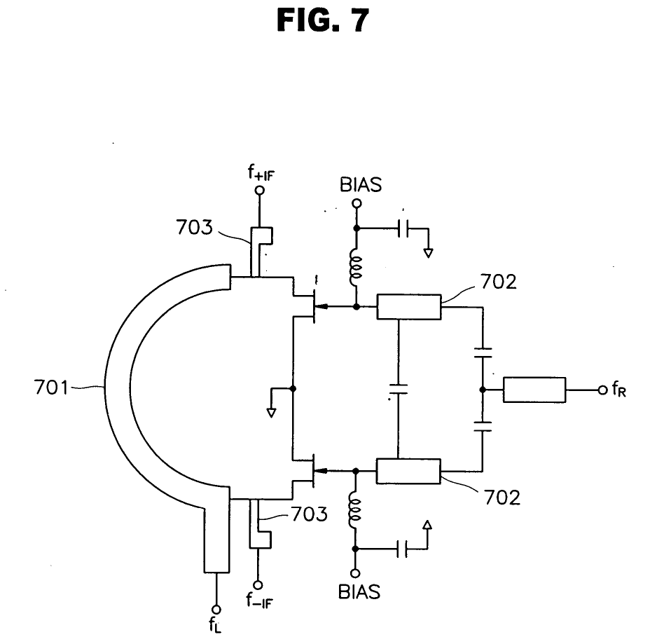

FIG. 7 is a circuit diagram of a resistive mixer using two HEMTs according to a second embodiment of the present invention. The structure of the circuit of FIG. 7 is the same as that of the circuit of FIG. 6, except that the position of input terminals to which a local oscillating signal f_{L} and a microwave signal f_{R}, which is received via an antenna, are input, respectively, are switched each other. A reference numeral 701 denotes a balun, and reference numerals 702 and 703 denote microstrips for filtering microwave on a substrate, respectively. The local oscillating signal f_{L}, which is oscillated by a local oscillator, is input to two drain terminals of two HEMT via the balun 701, and the microwave signal f_{R} is input to two gate terminals via the microstrips 702, together with bias voltage. Also, two intermediate frequency signals f_{+IF} and f_{-IF}, which have frequency corresponding to a difference between the frequency of the local oscillating signal f_{L} and the frequency of the microwave signal f_{R}, but are 180° out of phase, are obtained from the drain terminals via the IF filter 703.

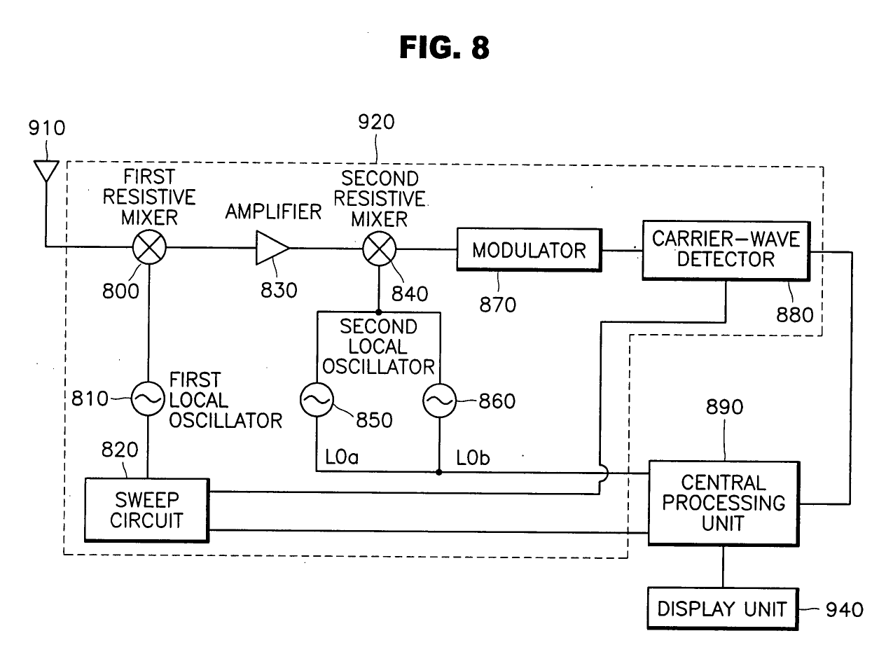

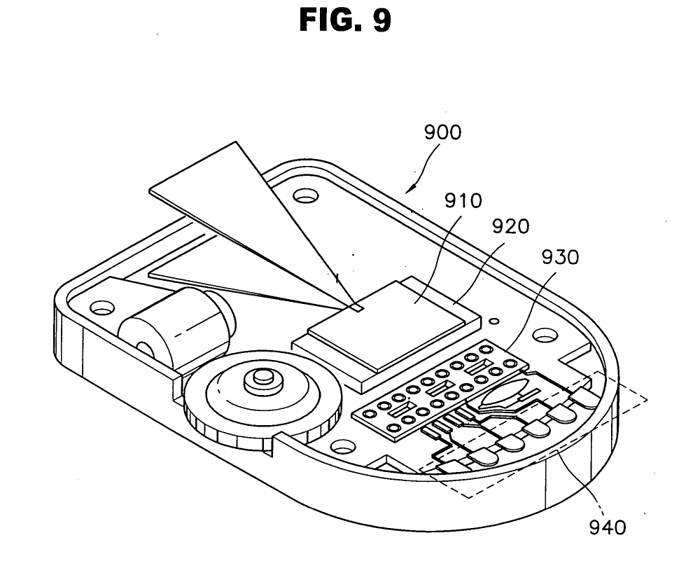

FIG. 8 is a block diagram of the structure of a microwave detector including a resistive mixer that uses an HEMT according to the present invention, and FIG. 9 is a view of the inner structure of a microwave detector including a resistive mixer that uses an HEMT according to the present invention. Please note that some of the components of the resistive mixers of FIGS. 6 and 7 were omitted for convenience' sake.

Referring to FIG. 9, a microwave detector 900 includes an antenna unit 910 that receives microwave; a modulator 920 that converts and amplifies the frequency of a signal received via the antenna unit 910, converts the amplified RF signal into an intermediate frequency signal, modulates the intermediate frequency signal, and filters the modulated signal; a central processing unit 930 that identifies the filtered signal, e.g., the frequency band and intensity of a signal, and outputs the same as a predetermined signal; and a display unit 940 that receives a signal generated by the central processing unit 930 to output a visual or audio signal, and further selects a mode of the output of a signal.

Referring to FIG. 8, a modulating unit 920 includes a first resistive mixer (or first resistive mixer) 800 that combines a signal input and a signal, which is generated by a first local oscillator 810, to output a first intermediate frequency signal; the first local oscillator 810 that outputs a signal whose frequency is changed within a predetermined range, e.g., from 11.4 GHz to 11.7 GHz, to the first resistive mixer 800; a sweep circuit 820 that enables for the first local oscillator to output a sawlike signal in response to carrier wave that is detected by a carrier-wave detector 880; an amplifier 830 that amplifies the first intermediate frequency signal output from the first resistive mixer 800; a second resistive mixer 840 that combines the first intermediate frequency signal output from the amplifier 830 and a signal generated by a second local oscillator 850, and output the same as a second intermediate frequency signal; a modulator 870 that modulates the original signal from the second intermediate frequency signal generated by the second resistive mixer 840; and the carrier-wave detector 880 that detects carrier wave from the signal generated by the modulator 870, and controls the operation of the sweep circuit 820 according to the frequency of the carrier wave detected. Here, the first resistive mixer 800 and the second resistive mixer 840 correspond to the resistive mixers that use the HEMT as shown in FIGS. 4 through 7.

While the present invention has been particularly shown and described with reference to preferred embodiments thereof, it will be understood by those skilled in the art that various changes in form and details may be made therein without departing from the spirit and scope of the invention as defined by the appended claims.

As compared to a conventional resistive mixer adopting a mixer diode, a resistive mixer including an FET, according to the present invention, is advantageous in that it has lower cross modulation distortion, I/F noise and scattering noise. Further, conversion loss in a resistive mixer including an FET, according to the present invention, is 0 dB in X-Band (10.525 GHz), 4 dB in K-Band (24 GHz) and 8 dB in Ka-Band (35 GHz), that is, it is also reduced by 2-0.3 dB on an average upon comparing with conversion loss in a resistive mixer adopting a mixer diode. Therefore, the performance of a microwave detector including such a resistive mixer, according to the present invention, is enhanced.

Also, a microwave detector including an FET according to the present invention is easy to make at a lower cost, hardly malfunctions, and further can operate with a little power.

What is claimed is:

1. A resistive mixer used in a microwave detector, wherein a local oscillating signal is input to a gate terminal of an FET, a microwave signal, which is received via an antenna, is input to a drain terminal of the FET, and an intermediate frequency signal, which is made by combining the local oscillating signal and the microwave signal, is output from the drain terminal of the FET.

2. The resistive mixer of claim 1, wherein the local oscillating frequency signal is input to a gate terminal of the FET via a filter, together with gate bias voltage, the microwave signal is input to the drain terminal of the FET via a filter, and the intermediate frequency signal is obtained from the drain terminal via a filter.

3. The resistive mixer of claim 1, wherein the local oscillating frequency signal is input to gate terminals of first and second FETs via a balun, together with gate bias voltage, the microwave signal is input to drain terminals of the first and second FETs, and first and second intermediate frequency signals, which are made by combining the oscillating frequency signal and the microwave signal, but are 180° out of phase, are obtained from the drain terminals of the first and second FETs via a filter.

4. A resistive mixer used in a microwave detector, wherein a local oscillating signal is input to a drain terminal of an FET, a microwave signal, which is received by an antenna, is input to a gate terminal of the FET, and an intermediate frequency signal, which is made by combining the oscillating frequency signal and the microwave signal, is output from the drain terminal of the FET.

5. The resistive mixer of claim 4, wherein the local oscillating frequency signal is input directly to the drain terminal of the FET via a filter, the microwave signal is input to the gate terminal of the FET via a filter, together with gate bias voltage, and a signal output, which is made by combining the oscillating frequency signal and the microwave signal, is obtained from the drain terminal via a filter.

6. The resistive mixer of claim 4, wherein the local oscillating signal is input to drain terminals of first and second FETs via a balun, the microwave signal is input to gate terminals of the first and second FETs together with gate bias voltage, and first and second intermediate frequency signals, which are made by combining the oscillating frequency signal and the microwave signal, but are 1800 out of phase, are obtained from the drain terminals of the first and second FETs via a filter.

7. A microwave detector comprising:
an antenna for receiving a radio signal;
a modulator for modulating the radio signal by converting its frequency with a resistive mixer that uses one or a plurality of FET;
a central processing unit for identifying the modulated signal and its frequency band, measuring the intensity of the signal, and outputting the same as a predetermined signal; and
a display unit for outputting a visual or audio signal in response to the signal generated by the central processing unit, and selecting a mode of the output of a signal.

8. The microwave detector of claim 7, wherein the modulator comprises:
a first local oscillator for outputting a signal whose frequency can be changed;
a first resistive mixer for combining the radio signal, which is received via the antenna, and a signal output from the first local oscillator to output an intermediate frequency signal, which is made by combining the radio signal and the signal output from the first local oscillator, using an FET;
an amplifier for amplifying the signal generated by the first resistive mixer;
a plurality of second local oscillator for outputting signals having different frequencies;
a second resistive mixer for combining the signal generated by the amplifier and the signal generated by the second local oscillator to output an intermediate frequency signal, which has frequency corresponding to a difference between the frequencies of these signals, using an FET;
a modulator for modulating the signal generated by the second resistive mixer, and outputting the same as pulses; and
a carrier-wave detector for detecting carrier wave from the signal generated by the modulator, and filtering the waveform of carrier wave.

9. The microwave detector of claim 8, wherein the local oscillating frequency signal generated by the first local oscillator is input to a gate terminal of the FET of the first resistive mixer, a microwave signal, which is received via an antenna, is input to a drain terminal of the FET, and an intermediate frequency signal, which is made by combining the local oscillating signal and the microwave signal, is obtained from the drain terminal via a filter.

10. The microwave detector of claim 8, wherein the local oscillating frequency signal generated by the first local oscillator is input to a drain terminal of the FET of the first resistive mixer, a microwave signal, which is received via an antenna, is input to a gate terminal, and an intermediate frequency signal, which is made by combining the local oscillating frequency signal and the microwave signal, is obtained from the drain terminal via a filter.

11. The microwave detector of claim 8, wherein the local oscillating frequency signal generated by one of the plurality of second local oscillator is input to a gate terminal of the FET of the second resistive mixer, the signal, which is generated by the amplifier, is input to a drain terminal of the FET, and an intermediate frequency signal, which is made by combining the local oscillating signal and the signal generated by the amplifier, is obtained from the drain terminal via a filter.

12. The microwave detector of claim 8, wherein the local oscillating frequency signal generated by one of the plurality of second local oscillator is input to a drain terminal of the FET of the second resistive mixer, the signal, which is generated by the amplifier, is input to a gate terminal, and an intermediate frequency signal, which is made by combining the local oscillating frequency signal and the signal generated by the amplifier, is obtained from the drain terminal via a filter.

13. The microwave detector of claim 7, wherein the modulator comprises:
a first local oscillator for outputting a signal whose frequency can be changed;
a first resistive mixer for combining the radio signal, which is received via the antenna, and a signal output from the first local oscillator to output an intermediate frequency signal, which is made by combining the radio signal and the signal output from the first local oscillator, using two FETs;
an amplifier for amplifying the signal generated by the first resistive mixer;
a plurality of second local oscillator for outputting signals having different frequencies;
a second resistive mixer for combining the signal generated by the amplifier and the signal generated by the second local oscillator to output an intermediate frequency signal, which has frequency corresponding to a difference between the frequencies of these signals, using two FETs;
a modulator for modulating the signal generated by the second resistive mixer, and outputting the same as pulses; and
a carrier-wave detector for detecting carrier wave from the signal generated by the modulator, and filtering the waveform of carrier wave.

14. The microwave detector of claim 13, wherein the local oscillating frequency signal generated by the first local oscillator is input to gate terminals of first and second FETs via a balun of the first resistive mixer, a microwave signal, which is received by an antenna, is input to drain terminals of first and second FETs of the first resistive mixer, and first and second intermediate frequency signals, that have frequency corresponding to a difference between the frequencies of the local oscillating frequency signal and the microwave signal, but are 180° out of phase, are obtained from the drain terminals of the first and second FETs via a filter.

15. The microwave detector of claim 13, wherein the local oscillating frequency signal generated by the first local oscillator is input to drain terminals of first and second FETs via a balun of the first resistive mixer, a microwave signal, which is received by an antenna, is input to gate terminals of first and second FETs of the first resistive mixer, and first and second intermediate frequency signals, that have frequency corresponding to a difference between the frequencies of the local oscillating frequency signal and the microwave signal, but are 180° out of phase, are obtained from the drain terminals of the first and second FETs via a filter.

16. The microwave detector of claim 13, wherein the local oscillating frequency signal generated by one of the plurality of second oscillator is input to gate terminals of first and second FETs via a balun of the second resistive mixer, the signal, which is generated by the amplifier, is input to drain terminals of first and second FETs of the second resistive mixer, and first and second intermediate frequency signals, that have frequency corresponding to a difference between the frequencies of the local oscillating frequency signal and the signal generated by the amplifier, but are 180° out of phase, are obtained from the drain terminals of the first and second FETs via a filter.

17. The microwave detector of claim 13, wherein the local oscillating frequency signal generated by one of the plurality of second oscillator is input to drain terminals of first and second FETs via a balun of the second resistive mixer, the signal, which is generated by the amplifier, is input to gate terminals of first and second FETs of the second resistive mixer, and first and second intermediate frequency signals, that have frequency corresponding to a difference between the frequencies of the local oscillating frequency signal and the signal generated by the amplifier, but are 180° out of phase, are obtained from the drain terminals of the first and second FETs via a filter.
